(19) United States
(12) Patent Application Publication
(10) Pub. No.: US 2026/0351004 A1
(43) Pub. Date: Nov. 5, 2026

(54) METHOD AND APPARATUS FOR INDICATOR LIGHT RECOGNITION

(71) Applicant: QUALCOMM Incorporated, San Diego, CA (US)

(72) Inventors: Rahul Ahuja, San Diego, CA (US); Varun Ravi Kumar, San Diego, CA (US); Senthil Kumar Yogamani, San Diego, CA (US)

(21) Appl. No.: 19/196,497

(22) Filed: May 1, 2025

(51) Int. Cl. G06V 20/58; G06V 10/44; G06V 10/764; G06V 10/80

(52) U.S. Cl. CPC G06V 20/584; G06V 10/44; G06V 10/764; G06V 10/806

(57) ABSTRACT

A method for indicator light detection and classification by a vehicle assistance system includes: obtaining multimodal data from a plurality of sensors; extracting a plurality of features from the multimodal data; combining the plurality of features using a multimodal feature fusion to generate a plurality of combined features; predicting, based on the plurality of combined features, behavior of a vehicle; identifying, based on the plurality of combined features, one or more indicator light candidate regions of the vehicle and performing geometric consistency analysis for the one or more indicator light candidate regions; performing, based on the plurality of combined features, spectral and temporal signal analysis; and concatenating, using a hierarchical attention-based fusion, prediction of the behavior of the vehicle with results of the geometric consistency analysis and results of the spectral and temporal signal analysis to generate a classification of indicator lights of the vehicle.

### TECHNICAL FIELD

This disclosure relates to computer vision.

### BACKGROUND

Detecting and accurately classifying a vehicle's indicator light status in real-world driving scenarios may be challenging for computer vision systems. The computer vision systems may use sensors such as, but not limited to, cameras, LiDAR, and radar to collect data and build a representation of the environment. In this context, lack of ambient light may make visual detection of indicator lights difficult for cameras. Heavy fog may obscure the view, scattering light and reducing visibility for both cameras and potentially radar. Strong light sources (e.g., headlights of oncoming vehicles, sunlight reflecting off surfaces) may saturate camera sensors, creating difficulties to discern fainter indicator lights. When other vehicles, objects, or even parts of the target vehicle itself (e.g., an open trunk) partially block the view of the indicator lights, both cameras and radar may have difficulties in getting a complete and reliable signal. Light reflecting off wet roads or other vehicles may create false positives or obscure the actual indicator lights.

### SUMMARY

This disclosure describes techniques related to computer vision, and more specifically to techniques for indicator light recognition. In one example, the disclosed techniques may be utilized by a vehicle assistance system (e.g., an advanced driver assistance system (ADAS)). The disclosed techniques may include fusing data from multiple sensors (e.g., RGB camera, Near-Infrared (NIR) camera, and LiDAR), including introducing a hierarchical cross-modal attention mechanism. This hierarchical cross-modal attention mechanism may go beyond simple feature concatenation by dynamically weighting the contributions of each sensor based on the current environmental conditions and the past performance of the system. A camera feature encoder may process data from one or more cameras (e.g., standard RGB color images). Furthermore, the camera feature encoder may utilize a hybrid Convolutional Neural Network (CNN)-Transformer architecture. The camera feature encoder may combine the local feature extraction capabilities of Convolutional Neural Networks (CNNs) with the global context understanding of Transformers. The camera feature encoder may include self-adjusting receptive fields. The receptive field of a neuron in a neural network may determine the region of the input it “sees.” In other words, this camera feature encoder may dynamically adjust the size of these receptive fields based on illumination conditions. For example, in low light, the camera feature encoder may expand the receptive field to gather more contextual information, while in bright light, the camera feature encoder may contract the receptive field to focus on finer details.

A NIR feature encoder may process data from one or more NIR cameras (e.g., which are more sensitive to infrared light). The NIR feature encoder may emphasize gradient transitions between high-intensity and low-intensity regions. The NIR feature encoder may be particularly effective for robust edge detection in low-light conditions, where traditional RGB camera images might lose detail. In addition, NIR imagery may often provide better contrast in such scenarios. A LiDAR feature encoder may process data from one or more LiDAR sensors. The LiDAR sensors may be configured to measure distance using laser pulses, creating 3D point clouds. The LiDAR feature encoder may employ a custom point-cloud voxelization method with dynamic resolution.

In addition to the above technical advantages, the techniques may provide one or more other technical advantages that realize at least one practical application. By dynamically weighing sensor inputs based on context and performance, the disclosed system may focus on the most relevant information for each situation. Sensor-specific feature encoders may be designed to excel in their respective domains (e.g., NIR in low light), making the disclosed system more resilient to challenging environmental conditions. Adaptive receptive fields and dynamic voxelization may optimize information capture and computational cost. Explicitly processing ambient context may allow the disclosed system to make more informed decisions. Precise temporal alignment and history verification may better ensure consistent and accurate interpretation of dynamic events.

In one example, a method for indicator light detection and classification by a vehicle assistance system, the method comprising: obtaining multimodal data from a plurality of sensors; extracting a plurality of features from the multimodal data; combining the plurality of features using a multimodal feature fusion to generate a plurality of combined features; predicting, based on the plurality of combined features, behavior of a vehicle; identifying, based on the plurality of combined features, one or more indicator light candidate regions of the vehicle and performing geometric consistency analysis for the one or more indicator light candidate regions; performing, based on the plurality of combined features, spectral and temporal signal analysis; and concatenating, using a hierarchical attention-based fusion, prediction of the behavior of the vehicle with results of the geometric consistency analysis and results of the spectral and temporal signal analysis to generate a classification of indicator lights of the vehicle.

In another example, a system for indicator light detection and classification by a vehicle assistance system includes a memory for storing multimodal data; and processing circuitry in communication with the memory. The processing circuitry is configured to obtain the multimodal data from a plurality of sensors and extract a plurality of features from the multimodal data. The processing circuitry is also configured to combine the plurality of features using a multimodal feature fusion to generate a plurality of combined features and predict, based on the plurality of combined features, behavior of a vehicle. The processing circuitry is further configured to identify, based on the plurality of combined features, one or more indicator light candidate regions of the vehicle, perform geometric consistency analysis for the one or more indicator light candidate regions and perform, based on the plurality of combined features, spectral and temporal signal analysis. Finally, the processing circuit is configured to concatenate, using a hierarchical attention-based fusion, prediction of the behavior of the vehicle with results of the geometric consistency analysis and results of the spectral and temporal signal analysis to generate a classification of indicator lights of the vehicle.

In yet another example, non-transitory computer-readable storage media having instructions encoded thereon, the instructions configured to cause processing circuitry to obtain multimodal data from a plurality of sensors and extract the plurality of features from the multimodal data. The instructions are also configured to combine the plurality of features using a multimodal feature fusion to generate a plurality of combined features and predict, based on the plurality of combined features, behavior of a vehicle. The instructions are further configured to identify, based on the plurality of combined features, one or more indicator light candidate regions of the vehicle, perform geometric consistency analysis for the one or more indicator light candidate regions and perform, based on the plurality of combined features, spectral and temporal signal analysis. Finally, the instructions are configured to concatenate, using a hierarchical attention-based fusion, prediction of the behavior of the vehicle with results of the geometric consistency analysis and results of the spectral and temporal signal analysis to generate a classification of indicator lights of the vehicle.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example vehicle, in accordance with the techniques of this disclosure.

FIG. 2 is a block diagram illustrating an example system that may perform the techniques of this disclosure.

FIG. 3 is a block diagram illustrating a high-level framework for multi-spectral indicator light detection and classification of a vehicle assistance system, in accordance with the techniques of this disclosure.

FIG. 4 is a flowchart illustrating an example method for indicator light detection and classification by a vehicle assistance system, in accordance with the techniques of this disclosure.

### DETAILED DESCRIPTION

Traditional approaches of a vehicle assistance system, such as an ADAS (Advanced Driver Assistance System), may encounter significant challenges in detecting and accurately classifying a vehicle's indicator light status. Internal reflections within the camera lens due to bright light sources may produce artifacts that may be mistaken for indicator lights. The constantly shifting light conditions in real-world driving (e.g., entering tunnels, passing under streetlights, varying cloud cover) may complicate reliance on fixed intensity thresholds for detection. What looks like an indicator light in one lighting condition may not in another lighting condition. In strong sunlight, the intensity of a lit indicator light may appear very subtle, potentially falling below a fixed detection threshold designed for darker conditions. Incorrectly perceiving that a vehicle ahead is braking (when it is not, or vice-versa) may lead to unsafe following distances, increasing the risk of rear-end collisions.

An ADAS is one type of vehicle assistance system. The ADAS is a collection of technologies or systems that may be integrated into a vehicle to enhance safety and improve driving experiences. These systems may use sensors, cameras, radar, LiDAR, and software to monitor the surroundings of a vehicle, analyze driving conditions, and either warn the driver of potential hazards or take partial or full control of the vehicle to prevent accidents. Examples of ADAS technologies may include, but are not limited to: Adaptive Cruise Control (ACC), Lane Departure Warning (LDW) and Lane Keeping Assist (LKA), Automatic Emergency Braking (AEB), blind spot detection, traffic sign recognition, parking assistance, and driving monitoring systems. The ACC may be configured to automatically adjust the vehicle's speed to maintain a safe distance from the vehicle ahead. The LDW and LKA may be configured to alert the driver when the vehicle unintentionally drifts out of its lane or actively steers the vehicle back into the lane. The AEB may be configured to detect potential collisions and to apply brakes to avoid or reduce the impact. The blind spot detection system may be configured to warn drivers of vehicles or objects in their blind spots. The traffic sign recognition system may be configured to identify and display traffic signs, such as speed limits or stop signs, to the driver. The parking assistance system may use sensors and cameras to assist with parking, sometimes automating the process. The driver monitoring system may be configured to detect driver fatigue or distraction and may issue alerts or may take corrective actions.

In some example ADAS the same indicator light in darkness could appear extremely bright, as opposed to very subtle in strong sunlight, potentially saturating a sensor or being misclassified if the ADAS is not robust to a wide dynamic range of light intensities. In other words, this variation in apparent brightness may make it difficult to rely on a simple, unchanging brightness level to determine if an indicator light is on, braking, or indicating. An ADAS may need to adapt to the ambient lighting conditions. Various weather conditions may significantly degrade visibility for optical sensors. Fog may scatter light, rain may obscure lenses, and snow may cover indicator lights or create reflective surfaces.

As discussed above, in the context of ADAS and computer vision, the lack of ambient light may complicate reliance solely on passive vision. The sensors may beneficially operate in non-visible parts of the electromagnetic spectrum (like infrared) which may be less affected by some of these conditions, or may require the fusion of data from multiple sensor types. Automakers may employ a wide range of designs for indicator lights. Some indicator lights may be small and dim, others may be large and bright. The placement of indicator lights on the vehicle may also vary. This diversity means that a simple detector trained on one type of indicator light may fail to recognize or accurately classify others. The detection component of ADAS may need to be adaptable and robust to these variations. The activation of turn signals and brake lights may be directly linked to the driver's intended maneuvers (lane changes, turns, stopping). If a system only looks at a single frame of video or a static sensor reading, the system may miss the important temporal patterns of flashing turn signals or the duration of brake light activation, which may provide information about the vehicle's intent.

It should be noted that understanding the sequence and timing of light changes may be important for accurate interpretation. In essence, these additional complexities highlight that reliably interpreting indicator light status may require more than just identifying a red light. Such interpretation may demand a sophisticated system that may adapt to varying lighting conditions. The system may need to be robust to adverse weather. As yet another example of a requirement, the system may need to recognize a wide variety of indicator light designs.

As noted above, one of the objectives of the disclosed techniques may be to create a reliable system capable of accurately detecting and classifying various indicator light states (brake, turn, reverse, etc.) under a wide range of challenging real-world driving conditions. For instance, this robustness may be achieved by leveraging the complementary strengths of different sensor types. The disclosed system distinguishes itself from simpler multi-sensor approaches that merely combine the raw features extracted from each sensor. Instead, the disclosed system introduces a hierarchical cross-modal attention mechanism.

In other words, the disclosed system may learn to assign different levels of importance (weights) to the information coming from each sensor (e.g., RGB, NIR, LiDAR) based on the prevailing circumstances. For example, in bright daylight, the RGB camera may provide the most reliable color and shape information, so input of the RGB camera may be weighted higher by the disclosed system. In dense fog, where visual cameras struggle, LiDAR's ability to perceive geometry or NIR's edge detection may become more important and thus may receive higher weights. The techniques of this disclosure may also consider how well each sensor has performed in the past under similar conditions. If a particular sensor has consistently provided noisy or inaccurate data in certain situations, contribution of that sensor may be down-weighted.

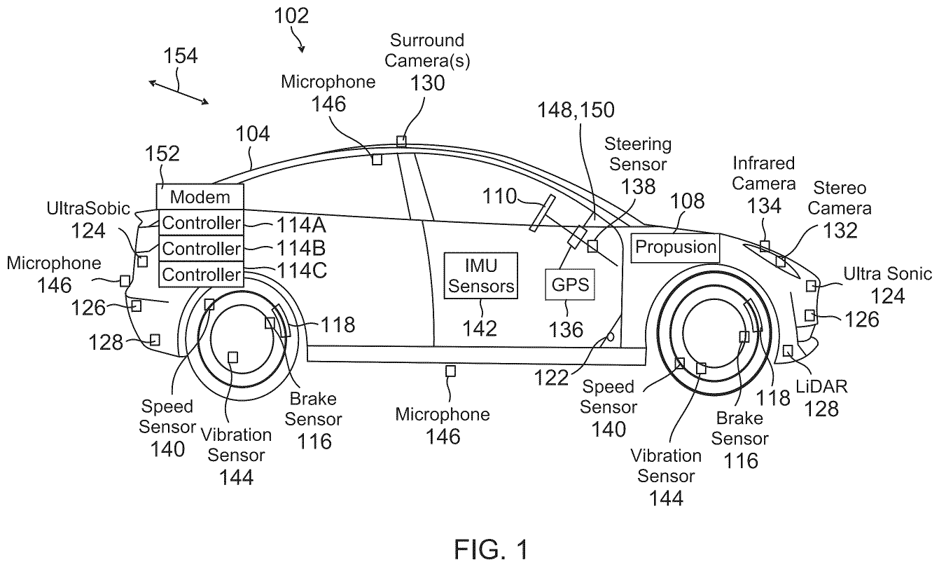

FIG. 1 shows an example vehicle 102. Vehicle 102 in the example shown may comprise a passenger vehicle such as a car or truck that can accommodate a human driver and/or human passengers. In an aspect, vehicle 102 may comprise a vehicle with an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide assistive capabilities in response to signals continuously provided in real-time from an array of sensors, as described more fully below.

Each controller 114 may be essentially one or more onboard computers that may be configured to perform deep learning and/or artificial intelligence functionality and output operation commands to self-drive vehicle 102 and/or assist the human vehicle driver in driving. Each vehicle may have any number of distinct controllers for functional safety and additional features. For example, controller 114A may serve as the primary computer for assistive driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, GPS data, tire pressure, fuel level, sonar, brake torque, and others. Similar actuation controllers may be configured for any other make and type of vehicle, including special-purpose cars, robo-taxis, long-haul trucks including tractor-trailer configurations, tiller trucks, agricultural vehicles, industrial vehicles, and buses.

Controller 114 may provide driving outputs in response to an array of sensor inputs including, for example: one or more ultrasonic sensors 124, one or more RADAR sensors 126, one or more LiDAR sensors 128, one or more surround view cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for assistive driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

Compared to sonar and RADAR sensors 126, cameras 130-134 may generate a richer set of features at a fraction of the cost. Thus, vehicle 102 may include a plurality of cameras 130-134, capturing images around the periphery of the vehicle 102. Camera type and lens selection depends on the nature and type of function. For example, one or more cameras 130-134 may capture light in the visible spectrum, which is the range of light that the human eye can see (approximately 400-700 nanometers in wavelength). This spectrum may be referred to as RGB spectrum and is composed of the primary colors red, green, and blue, and combinations of these colors create the full spectrum of colors people perceive. In addition, One or more cameras 130-134 may capture light in the near-infrared (NIR) spectrum, which is just beyond the visible red light (typically from about 700 nanometers to 1400 nanometers). This light is invisible to the human eye. The vehicle 102 may have a mix of camera types and lenses to provide complete coverage around the vehicle 102. All camera locations on the vehicle 102 may support interfaces such as Gigabit Multimedia Serial link (GMSL) and Gigabit Ethernet.

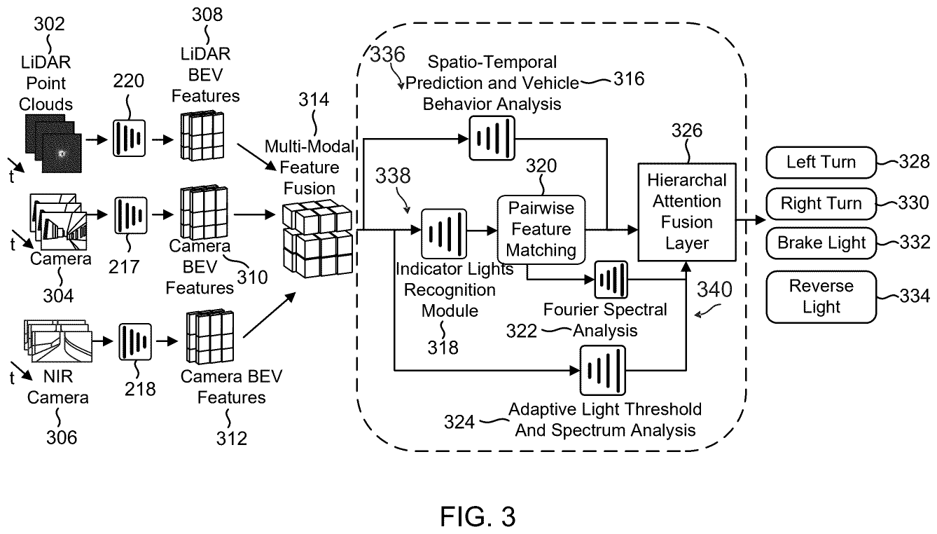

In an aspect, a controller 114 may be configured to obtain multimodal input data from a plurality of sensors of vehicle 102. For example, the camera pictures (e.g. a pictures shown in FIG. 3), NIR data and LiDAR data may provide a comprehensive view of the environment surrounding a vehicle assistance system. Next, controller 114 may extract a plurality of features from the multimodal data. As a non-limiting example, these features may be intended to capture the most important information from each modality for the task of indicator light detection and classification. Controller 114 may then combine the plurality of features using a weighted fusion technique to generate a plurality of combined features. In an aspect, controller 114 may apply equation (4) described below to perform this fusion technique. Next, controller 114 may predict, based on the plurality of combined features, behavior of the vehicle. In an aspect, a trajectory prediction module may output a vector

$${b}_{traj}^{( t )}$$

that may include probabilities of discrete vehicle behaviors (turning left, turning right, braking, reversing) predicted by a novel predictive decoder (see equation (15) below). In accordance with the techniques of the present disclosure, controller 114 may also identify, based on the plurality of combined features, one or more indicator light candidate regions and may perform geometric consistency analysis for the one or more indicator light candidate regions. The function described by equation (19) below may evaluate the geometric consistency based on a model of typical indicator light spacing and height difference. In addition, controller 114 may perform, based on the plurality of combined features, spectral and temporal signal analysis. This analysis may help in distinguishing indicator lights from other light sources by examining their characteristic spectral properties and temporal behaviors (like flickering for LED turn signals). Finally, controller 114 may concatenate, using a hierarchical attention-based fusion, prediction of the behavior of the vehicle with results of the geometric consistency analysis and results of the spectral and temporal signal analysis to generate classification of detected indicator lights of the vehicle. In essence, the hierarchical attention-based fusion mechanism may work by processing the outputs of the three specialized branches, as described below.

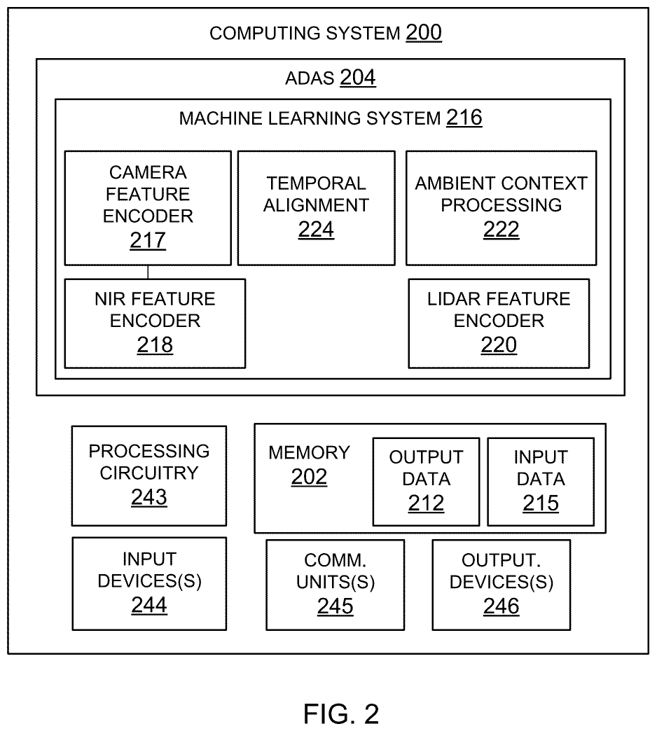

FIG. 2 is a block diagram illustrating an example computing system 200. As shown, computing system 200 comprises processing circuitry 243 and memory 202 for executing Machine Learning (ML) system 216 of ADAS 204, including camera feature encoder 217, NIR feature encoder 218, LIDAR feature encoder 220, ambient context processing module 222, and temporal alignment module 224 which may represent an example instance of any controller 114 described in this disclosure, such as controller 114 of FIG. 1. ML system 216 may comprise various types of neural networks, such as, but not limited to, recursive neural networks (RNNs), convolutional neural networks (CNNs), and deep neural networks (DNNs). For example, ML system 216 may also include an object detection model not shown in FIG. 2.

Computing system 200 may also be implemented as any suitable external computing system accessible by controller 114, such as one or more server computers, workstations, laptops, mainframes, cloud computing systems, High-Performance Computing (HPC) systems (i.e., supercomputing) and/or other computing systems that may be capable of performing operations and/or functions described in accordance with one or more aspects of the present disclosure.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules or units described in accordance with one or more aspects of this disclosure.

Processing circuitry 243 and memory 202 may provide an operating environment or platform for one or more modules or units (e.g., camera feature encoder 217, NIR feature encoder 218, LiDAR feature encoder 220, ambient context processing module 222, and temporal alignment module 224), which may be implemented as software, but may in some examples include any combination of hardware, firmware, and software. Processing circuitry 243 may execute instructions and the one or more storage devices, e.g., memory 202, may store instructions and/or data of one or more modules or units. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute ADAS 204 using virtualization modules, such as a virtual machine or container executing on underlying hardware. One or more of such modules may execute as one or more services of an operating system or computing platform. Aspects of ADAS 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, hierarchical attention fusion layer may generate output data 212. The output data 212 of the scene representation and fusion module may be used as input data 215 for the path planning module. Input data 215 and output data 212 may contain various types of information. For example, multimodal input data 215 may include, but is not limited to, camera image data, LiDAR point cloud 302 data, NIR data, and so on. Output data 212 may include the indicator light classification data including indicator light states (brake, turn, reverse, etc.) and the like.

As noted above, one of the objectives of the disclosed techniques may be to create a system that may more consistently and accurately perform its intended task. Reliability may be important, especially in safety-related applications like ADAS. The ML system 216 may utilize data from three different types of sensors. Standard color cameras (e.g., RGB cameras) may provide visual information. Sensors that capture light in the near-infrared spectrum may often be useful in low-light conditions as the NIR sensors may be less affected by visible darkness. LiDAR is a sensor that uses laser pulses to measure distances to surrounding objects, generating a 3D point cloud of the environment. Integrating multiple sensor modalities is typically a common strategy to improve robustness by leveraging the complementary strengths of each sensor. The specific task of the ML system 216 may be to identify the presence of vehicle indicator lights and then categorize the identified indicator lights into different types (e.g., brake lights being on, turn signal activated, reverse lights illuminated). The ML system 216 may perform well despite changes in the environment, such as different lighting conditions (day, night, shadows), weather (rain, fog), and sensor noise.

Robustness may be one of the challenges in real-world applications. In assistive driving, traditional approaches may extract the features from each sensor and may combine (concatenate) the extracted features into a single, longer feature vector before further processing. Traditional approaches may not be optimal for effectively fusing information from diverse sensors.

The term “hierarchical cross-modal attention mechanism,” as used herein, refers to the attention mechanism that operates at multiple levels or stages, allowing for a more nuanced understanding of the sensor data. The attention mechanism may consider the relationships and interactions between the different sensor modalities (e.g., RGB, NIR, LiDAR). The attention mechanism may not treat the different sensor modalities in isolation. An attention mechanism may allow the ML system 216 to focus on the most relevant parts of the input data. In this context, the attention mechanism may enable the disclosed system to prioritize information from different sensors based on their usefulness for the current task. The attention mechanism may not simply assign fixed weights to each sensor. Instead, the attention mechanism may be trained to adjust these weights dynamically based on, for example, environmental conditions and historical performance. For example, in low light, the NIR sensor may be given more weight than the RGB sensor. The ML system 216 may be trained to weight a particular sensor more if that particular sensor has consistently provided accurate information in similar situations in the past. Components of the ML system 216 may include encoders that are tailored to each sensor type and that may have the ability to adjust their “view” of the data. In other words, there may be a separate processing module (an “encoder”) designed specifically for each sensor modality (e.g., RGB, NIR, and LiDAR).

ML system 216 may be configured such that each encoder effectively extracts relevant features from the unique data format of its corresponding sensor. The term “receptive field” of a neuron in a convolutional neural network (CNN) refers to the region of the input data that the neuron is sensitive to. Advantageously, these receptive fields may change or adjust their size and shape during the processing, potentially allowing the encoders to focus on different scales of features depending on the input.

Camera feature encoder 217 may be responsible for processing the RGB images 304 and generating camera Bird's Eye View (BEV) features 310. The camera feature encoder 217 may combine two powerful deep learning architectures: CNNs and transformers. Convolutional Neural Networks (CNNs) are typically well-suited for processing image data, extracting spatial hierarchies of features (edges, textures, shapes). Originally designed for natural language processing, transformers typically excel at capturing long-range dependencies and contextual information in sequential data. Application of transformers in vision has shown promising results.

The hybrid nature of the camera feature encoder 217 may leverage the strengths of both architectures. The receptive fields of the CNN components within this hybrid architecture may dynamically change size depending on how bright or dark the scene is. This could allow the camera feature encoder 217 to focus on finer details in bright conditions and broader contexts in low-light scenarios.

The NIR feature encoder 218 may be responsible for processing the near-infrared images 306 and generating NIR BEV features 312. The NIR feature encoder 218 may be designed to focus on the sharp changes in intensity in the NIR images 306. These gradients may correspond to edges of objects, which may be particularly useful for detection and segmentation, especially when color information is limited in low light. The design choice of the ML system 216 may be specifically motivated by the need to perform well when visible light is scarce, where NIR imaging may still provide significant information about object boundaries. The LiDAR feature encoder 220 may be responsible for processing the 3D point cloud data 302 from the LiDAR sensor and generating a plurality of BEV features 308. LiDAR data is typically a collection of 3D points. “Voxelization” is a technique that may be used to convert this sparse point cloud into a 3D grid of voxels (volumetric pixels), making the point cloud more amenable to processing by 3D convolutional networks.

Voxelization may convert the unstructured point cloud into a 3D grid of voxels (volumetric pixels). The dynamic resolution may allow the 3D grid to preserve fine details at close range by using smaller voxels, while efficiently handling sparse distant points by using larger voxels. The LiDAR feature encoder may optimize computational resources without sacrificing important information. In addition, an ambient context processing module may analyze various environmental factors, such as, but not limited to, ambient light levels, weather conditions, and traffic patterns. The ambient light levels may include the overall brightness of the surroundings. The weather conditions may include, but are not limited to: rain, fog, snow, etc.

The term “traffic patterns,” as used herein, refers to the flow and density of vehicles or pedestrians. The ambient context processing module may generate contextual embeddings. The contextual embeddings may be numerical representations of the analyzed environmental information. In addition, these embeddings may modulate the behavior of the three specialized branches (the RGB, NIR, and LiDAR feature encoders). In other words, the environmental context may influence how each encoder processes respective sensor data. The ambient context processing module may also provide continuous environmental calibration factors for adaptive thresholding.

The term “thresholding,” as used herein, refers to a common technique in image and signal processing to separate different regions or identify objects. These calibration factors may dynamically adjust the thresholds used in the disclosed system based on the environmental context, making the disclosed system more robust to varying conditions. In addition, a temporal alignment module may focus on synchronizing the data from the different sensors in time.

Generally, voxelization may be a specifically designed method. In the context of an ADAS, in one example, the size of the voxels in the grid may not be fixed. The size of the voxels may change depending on the location of the points. When objects are close to the sensor, the point cloud may be denser, and a higher voxel resolution may capture more intricate details.

The ambient context processing module 222 may be responsible for understanding the surrounding environment to help the ML system 216 make more informed decisions about indicator light detection and classification. In the context of 3D object detection, the ambient context processing module 222 may do this by analyzing several key factors, such as, but not limited to: analyzing ambient light level, weather conditions and traffic patterns. In an aspect, the analysis of ambient light levels may involve determining how bright or dark the environment is.

This information about ambient light levels may be important because the visibility and characteristics of indicator lights may change significantly between day and night. The weather conditions may include factors such as but not limited to: rain, fog, snow, or clear skies.

Weather may obscure or distort sensor readings and may affect the appearance of indicator lights. The analysis of traffic patterns may involve understanding the density and flow of traffic. For example, in heavy traffic, the ML system 216 may need to be more sensitive to brake lights. Based on the analysis of the ambient conditions, the ambient context processing module 222 may create contextual embeddings.

The contextual embeddings may be numerical representations of the environmental context. These embeddings may then be used by the ML system 216 to modulate or adjust how the three sensor-specific branches (RGB, NIR, LiDAR feature encoders) process their respective data.

Still referring to FIG. 2, the contextual embeddings may allow the ML system 216 to prioritize information from different sensors or adjust the corresponding processing parameters based on the environment. For instance, in low light, the contextual embeddings may increase the influence of the NIR branch. Thresholding is a common technique in computer vision to separate objects of interest from the background.

As explained earlier, “adaptive thresholding” means that these thresholds are not fixed but may change based on the environmental conditions. The calibration factors from the ambient context processing module 222 may better ensure that the thresholds used for detecting and classifying indicator lights are appropriate for the current ambient context, making the ML system 216 more robust to variations in the environment.

The ambient context processing module 222 may act like the “environmental awareness” of the ML system 216. The ambient context processing module 222 may observe the surroundings and may provide information that helps the other parts of the ML system 216 (the sensor-specific branches) adjust their behavior to work best in the current conditions. The temporal alignment module 224 may address the challenge of integrating data that comes from different sensors at potentially different times or with inherent delays. The temporal alignment module 224 may better ensure that the data from the RGB camera, NIR camera, and LiDAR sensor that are considered to be from the same point in time are accurately aligned. In an aspect, sub millisecond precision may indicate a very high level of synchronization. Different sensors may have different delays in capturing and processing data (latency) and may acquire data at different frequencies (sampling rates).

In one example, the temporal alignment module 224 may account for the aforementioned differences to better ensure that the data being fused is temporally consistent. In addition, the temporal alignment module 224 may be configured to keep a record of recent sensor data.

This history buffer may allow the ML system 216 to check if the current sensor readings are consistent with the immediate past. For example, if brake lights were just activated, the ML system 216 may expect to see a consistent signal across all synchronized sensor inputs. This helps to filter out noise or spurious readings.

The history buffer may help to filter out noise or spurious readings. In simpler terms, the temporal alignment module 224 may better ensure that the data from all the different sensors is correctly lined up in time before that data is processed further.

In an aspect, in certain operations, the temporal alignment module 224 may make sure all the different sensors of the ML system 216 are looking at the same moment in time. The ML system 216 may receive multiple primary input data streams at each time point. Advantageously, the first input stream—I^{(t)}_{RGB} may represent the color image captured by the RGB camera at time t.

As noted above, the I^{(t)}_{RGB} may be a 2D array of pixel values, where each pixel typically has red, green, and blue intensity values. The second input stream I^{(t)}_{NIR} may represent the near-infrared image captured by the NIR camera at time t.

In an aspect, similar to the RGB image, the I^{(t)}_{NIR} may be a 2D array of pixel values, but representing the intensity of light in the near-infrared spectrum. For example, P^{(t)}_{LiDAR} may represent the set of 3D point-cloud data obtained from the LiDAR sensor at time t. The P^{(t)}_{LiDAR} may be a collection of individual points in 3D space, where each point typically has coordinates (x, y, z) and possibly other attributes like reflectivity. In addition, one of the primary objectives of the ML system 216 may be to predict the state of the vehicle's indicator lights at each time step t. This prediction may be represented by the following set:

S^{(t)}={s_{left},s_{right},s_{brake},sᵣₑᵥₑᵣₛₑ}

In other words, each element in this set may represent the confidence level (a value between 0 and 1, inclusive) that the corresponding indicator light function may be active.

In the context of indicator light recognition, the term s_{left}∈[0,1] may be the confidence that the left turn signal is active. A value closer to 1 may indicate higher confidence. The term s_{right}∈[0,1] may be the confidence that the right turn signal is active. The term s_{brake}∈[0,1] may be the confidence that the brake lights are active. The term sᵣₑᵥₑᵣₛₑ∈[0,1] may be the confidence that the reverse lights are active.

In an example, before the information from the different sensors (RGB, NIR, LiDAR) is combined (fused), each individual sensor's data may be processed to extract relevant features. As a non-limiting example, these features may be intended to capture the important information from each modality for the task of indicator light detection and classification. In other words, the following equation (1) describes how features are extracted from the RGB image at time t:

$${f}_{rgb}^{( t )} = {E}_{RGB} ( {I}_{RGB}^{( t )} ) \qquad ( 1 )$$

As defined above, the term

$${I}_{RGB}^{( t )}$$

may represent the input RGB image at time t.

The term E_{RGB} may denote the RGB feature extraction network. In the context of indicator light detection, the feature extraction may be a function or a series of operations (e.g., a neural network) that takes the RGB image as input and transforms the image into a feature representation. Advantageously, the term f_{rgb}^{(t)} may be the output feature vector (or feature map) generated by the RGB feature extraction network for the input RGB image at time t. This vector (or map) may be a more compact and informative representation of the RGB image, highlighting features relevant to indicator lights. The initial part of the term E_{RGB} network may be a Convolutional Neural Network (CNN).

In an aspect, CNNs may be well-suited for processing image data and may be designed to automatically learn hierarchical spatial features, such as, but not limited to, edges, corners, and more complex shapes, from the image. Furthermore, this backbone may help in identifying potential regions of interest that may contain indicator lights. In an aspect, following the backbone CNN, the network may include attention modules.

For example, the attention modules may be designed to weigh different spatial regions of the feature maps based on the relevance of regions to indicator lights. Regions that exhibit characteristics commonly associated with indicator lights (e.g., shape, intensity in the red channel) may be assigned higher importance, allowing the ML system 216 to focus on these areas and suppress irrelevant information. The E_{RGB} network may also perform operations on the color information of the RGB image. Since indicator lights are typically red, these transformations may enhance the red channel and potentially suppress other color information that is less relevant for detecting indicator lights. In the context of ADAS, the color-space transformations may involve converting the RGB image to a different color space (e.g., HSV, where hue represents color) and then focusing on the red components.

The following equation (2) describes the feature extraction process for the Near-Infrared (NIR) image at time t:

$${f}_{nir}^{( t )} = {E}_{NIR} ( {I}_{NIR}^{( t )} ) \qquad ( 2 )$$

The term

$${I}_{NIR}^{{( t )}_{)}}$$

may represent the input NIR image at time t.

The term E_{NIR} may denote the NIR feature extraction network, Similar to the term E_{RGB}, the term E_{NIR} may be a function or a neural network specifically designed to process NIR images 306 and extract relevant features.

In accordance with the techniques of the present disclosure, the term

$${f}_{nir}^{( t )}$$

may be the output feature vector (or feature map) generated by the NIR feature extraction network for the input NIR image at time t. This representation may capture information from the NIR image that is useful for indicator light detection, especially in low-light conditions where NIR may provide better contrast for certain features like edges.

The following equation (3) describes how features are extracted from the LiDAR point cloud data at time t:

$${f}_{lidar}^{( t )} = {E}_{LiDAR} ( {P}_{LiDAR}^{( t )} ) \qquad ( 3 )$$

The term

$${P}_{LiDAR}^{( t )}$$

may represent the input LiDAR point cloud 302 data at time t. LiDAR (Light Detection and Ranging) sensors may generate a 3D point cloud representing the surrounding environment by measuring the distance to objects using laser pulses. This data may include the 3D coordinates (x, y, z) of each point and potentially other information like intensity of the reflected laser beam. In the example illustrated in FIG. 2, the term E_{LiDAR} may denote the LiDAR feature encoder 220.

The term E_{LiDAR} may be a function or a series of operations (likely a neural network specifically designed for point cloud data) that may take the raw LiDAR point cloud 302 as input and may transform the point cloud into a feature representation. For example, networks like PointNet, PointNet++, or other graph-based neural networks may be used for processing point cloud data.

The term

$${f}_{lidar}^{( t )}$$

may be the output feature vector (or feature map) generated by the LiDAR feature encoder 220 for the input point cloud at time t. In an aspect, this representation may capture geometric and potentially reflective properties of the environment relevant to identifying indicator lights. In an aspect, LiDAR may provide valuable information about the shape, size, and spatial location of objects, which may complement the information from RGB and NIR imagery, especially in challenging lighting or weather conditions. The following equation (4) describes a simple method to combine the features extracted from the RGB, NIR, and LiDAR modalities, using the multimodal feature fusion 314:

$${f}_{fused}^{( t )} = {W}_{rgb} \cdot {f}_{rgb}^{( t )} + {W}_{nir} \cdot {f}_{nir}^{( t )} + {W}_{lidar} \cdot {f}_{lidar}^{( t )} \qquad ( 4 )$$

The term

$${f}_{fused}^{( t )} :$$

may be the fused feature representation at time t. The term

$${f}_{fused}^{( t )}$$

may be the result of combining the individual modality features.

The terms

$${f}_{rgb}^{( t )} , {f}_{nir}^{{( t )}_{)}} and {f}_{lidar}^{( t )}$$

may be the feature representations extracted from the RGB, NIR, and LiDAR data, respectively, as defined in equations (1), (2), and (3). The terms W_{rgb}, Wₙᵢᵣ, and W_{lidar} may be weighting factors assigned to each modality's feature representation. As noted above, these weights may determine the relative contribution of each modality to the final fused feature. The ML system 216 may use an initial heuristic technique where the importance of each modality may be adjusted based on the prevailing environmental conditions. For example, during the day with clear weather, RGB may be assigned a higher weight due to good visibility and color information. In an aspect, at night or in foggy conditions, NIR and LiDAR may receive higher weights as the NIR and LiDAR may be less affected by poor illumination or visual obstructions. In heavy rain, LiDAR may be more reliable for geometric information. The initial, rule-based weight assignments may be further optimized through a learning process. By training the ML system 216 on a large dataset of various environmental conditions and corresponding sensor data, the optimal weights for each modality may be learned to maximize the performance of the indicator light detection system. In the context of the advanced 3D scene understanding, this learning process may involve techniques like backpropagation in a neural network where the fusion layer may adapt the weights based on the loss function of a task.

The following equation (5) describes an enhancement to the RGB feature extraction process:

$${f}_{rgb}^{( t )} = {E}_{RGB} ( {I}_{RGB}^{( t )} , {α}^{( t )} ) \qquad ( 5 )$$

The camera feature encoder 217 (E_{RGB}) may no longer be processing the input RGB image at a fixed resolution. Instead, the camera feature encoder 217 may adapt processing based on some dynamic factor. This modified equation (5) for RGB feature extraction now shows that the output features

$${f}_{rgb}^{( t )}$$

are not only a function of the input RGB image

$${I}_{RGB}^{( t )}$$

but also or an additional input α^{(t)}. The following equation (6) clarifies the role and determination of the dynamic parameter α^{(t)} introduced in the previous equation (5):

$${α}^{( t )} = {ϕ}_{context} ( {I}_{RGB}^{( t )} , {I}_{RGB}^{( t - 1 )} , … , {I}_{RGB}^{( t - k )} ) \qquad ( 6 )$$

In an aspect, the term α^{(t)} may not be just about resolution in a simple sense (like image downsampling). Instead, the term α^{(t)} may be a parameter that guides the spatial attention mechanisms within the camera feature encoder 217.

In one example, spatial attention modules in neural networks may learn to assign different importance weights to different spatial regions of the input feature maps. By controlling these attention mechanisms, α^{(t)} may allow the encoder to focus on the most relevant spatial areas for indicator light detection. Advantageously, the equation (6) shows how the term α^{(t)} is calculated. The term φ_{contex} may represent a function (likely another neural network or a set of processing steps) that may analyze the context to determine the appropriate spatial attention strategy.

Accordingly, the terms

$${I}_{RGB}^{( t )} , {I}_{RGB}^{( t - 1 )} , … , {I}_{RGB}^{( t - k )}$$

indicate that the context being considered may include not only the current RGB image at time t but also a history of past RGB images 304, going back k time steps. In an aspect, this temporal information may be valuable for understanding motion, changes in lighting, and the persistence of potential indicator light signals over time. In poor lighting, indicator lights might be faint or less clearly defined.

In such cases, the term α^{(t)} may guide the attention modules to consider broader spatial regions to capture any weak signals or potential areas where indicator lights may be present. In an aspect, the ML system 216 may be looking for more general reddish blobs initially. As a non-limiting example, when lighting is good, indicator lights are likely to be more distinct.

In other words, here, the term α^{(t)} may instruct the attention mechanisms to focus on more precise spatial regions, allowing for a more detailed analysis of the shape, boundaries, and finer characteristics of the indicator lights to improve detection accuracy and potentially classification. The following equation (7) describes an improvement to the NIR feature extraction process:

$${f}_{nir}^{( t )} = {E}_{NIR} ( {I}_{NIR}^{( t )} ⊙ {T}_{compensation} ( {T}_{ambient} ) ) \qquad ( 7 )$$

The equation (7) shows that before the NIR image 306

$${I}_{NIR}^{( t )}$$

is fed into the E_{NIR} (NIR feature encoder 218, the NIR image 306 may undergo a thermal compensation step. The symbol ⊙ represents element-wise multiplication. In other words, each pixel value in the NIR image 306 may be multiplied by a corresponding value from the thermal compensation function.

The term T_{compensation} may be a thermal compensation function. For illustrative purposes only, the thermal compensation function may take the ambient temperature (T_{ambient}) as input and may produce a set of correction factors (e.g., a map of the same dimensions as the NIR image 306). The function may be designed to model and counteract the effects of temperature variations on the NIR sensor's readings. Different temperatures may affect the sensitivity of the sensor and may introduce noise or biases in the pixel values. The thermally compensated NIR image 306 may then be passed through the E_{NIR} encoder to extract the features

$${f}_{nir}^{( t )} .$$

In essence, this thermal compensation step may improve the robustness and reliability of the NIR data by reducing the impact of environmental temperature fluctuations on the output of the sensor, leading to more accurate and consistent feature extraction.

In an aspect, the following equation (8) describes an enhancement to the LiDAR feature processing:

$${f}_{lidar}^{( t )} = {E}_{LiDAR} ( Voxelize ( {P}_{LiDAR}^{( t )} , δ ( d ) ) ) \qquad ( 8 )$$

The equation (8) indicates that the raw LiDAR point cloud 302

$${P}_{LiDAR}^{( t )}$$

may be first processed by a voxelization step before being fed into the E_{LiDAR} encoder (LiDAR feature encoder 220). Voxelization may be a technique to discretize a 3D space into small cubic units called voxels.

The points within each voxel may then be aggregated (e.g., by taking the average position or the number of points) to create a more structured representation of the point cloud. The term δ(d) may be a distance-dependent voxel size function. In other words, the size of the voxels used for discretization may not be fixed but may vary based on the distance (d) of the points from the sensor (or potentially the region of interest). For objects that are close to the sensor, a finer voxel resolution may be used (smaller voxels). This may allow for a more detailed representation of the shape and structure of the object, which may be important for accurate detection and classification. For objects that are farther away, a coarser voxel resolution may be used (larger voxels). Over time, since distant objects occupy fewer points in the point cloud and have less detail, using larger voxels may reduce the computational cost of processing the data without losing significant information relevant to the task.

The following equation (9) defines a temporal window H(t) at the current time t:

$$H ( t ) = \{ ( {f}_{rgb}^{( t - k )} , {f}_{nir}^{( t - k )} , {f}_{lidar}^{( t - k )} ) \vert k ∈ \{ 0 , 1 , … , K - 1 \} \} \qquad ( 9 )$$

This temporal window may aggregate the feature representations from all three sensor modalities (RGB, NIR, LiDAR) over a sequence of past time steps. The term H(t) may represent the multi-modal temporal history up to time t. However, this temporal history may be a set containing tuples of features from previous time instances. The term

$${f}_{rgb}^{( t - k )} , {f}_{nir}^{( t - k )} , {f}_{lidar}^{( t - k )} ) \vert$$

may be a tuple containing the feature vectors extracted from the RGB, NIR, and LiDAR data at a specific past time step t−k. The term k∈{0, 1, . . . , K−1} may define the range of past time steps included in the window. The time step k=0 may correspond to the current time t. The time step k=1 may correspond to the previous time step t−1 . . . k=K−1 may correspond to the time step t−(K−1). The term K may be the size of the temporal window, determining how many past time steps are considered. In essence, the temporal window H(t) may create a snapshot of the recent history of the scene as perceived by all three sensors, capturing how the extracted features have evolved over the last K time steps. This temporal window may allow the ML system 216 to go beyond analyzing just the current frame and consider temporal dynamics. The following equations (10)-(12) describe a hierarchical recurrent network designed to process the temporal information captured in H(t) at different time scales:

$${h}_{short}^{( t )} = {GRU}_{short} ( {H}_{0 : s}^{( t )} ) \qquad ( 10 )$$

$${h}_{medium}^{( t )} = {LSTM}_{medium} ( {H}_{0 : m}^{( t )} ) \qquad ( 11 )$$

$${h}_{long}^{( t )} = {LSTM}_{long} ( {H}_{0 : l}^{( t )} ) \qquad ( 12 )$$

Recurrent Neural Networks (RNNs) may be well-suited for processing sequential data like video frames or time-series data, as these networks have internal memory that allows them to retain information from past inputs.

In an aspect, the terms GRUₛₕₒᵣₜ, LSTM_{medium}, LSTM_{long} may represent three different recurrent network layers. The GRU (Gated Recurrent Unit) may be a type of RNN layer that is effective at capturing short-term dependencies in sequential data. The LSTM (Long Short-Term Memory) may be another type of RNN layer that is better at capturing both short-term and long-term dependencies due to more complex memory cell structure of that layer. The subscripts “short,” “medium,” and “long” indicate that these RNNs layers may be configured or trained to focus on different temporal horizons. The terms

$${H}_{0 : s}^{( t )} , {H}_{0 : m}^{( t )} , and {H}_{0 : l}^{( t )}$$

may denote sequences of the multi-modal temporal windows H up to different time horizons. The term

$${H}_{0 : s}^{( t )}$$

may represent the sequence of temporal windows from the beginning (time 0) up to a relatively short time horizon tₛ. The GRUₛₕₒᵣₜ network layer may process this shorter sequence to capture immediate temporal patterns. The term

$${H}_{0 : m}^{( t )}$$

may represent the sequence of temporal windows up to a medium-length time horizon tₘ (s<m). The LSTM_{medium} network layer may process this longer sequence to capture mid-term temporal dependencies. The term

$${H}_{0 : l}^{( t )}$$

may represent the sequence of temporal windows up to a long time horizon t₁ (m<l). The LSTM_{long} network layer may process this even longer sequence to capture long-term temporal patterns. The terms

$${h}_{short}^{( t )} , {h}_{medium}^{( t )} and {h}_{long}^{( t )}$$

may be the hidden state vectors output by each of the recurrent networks at the current time t. These hidden states may encapsulate the learned temporal information at their respective time scales. Short temporal horizon (s and GRUₛₕₒᵣₜ) may allow the ML system 216 to quickly detect immediate changes, such as, but not limited to, the sudden activation of brake lights. GRUs are efficient for capturing such recent events. Medium temporal horizon (m and LSTM_{medium}) may enable the ML system 216 to recognize patterns that unfold over a slightly longer duration, like the blinking pattern of a turn signal. In an aspect, LSTMs may be better suited for capturing these mid-range dependencies. Long temporal horizon (1 and LSTM_{long}) may help the ML system 216, for example, to understand even longer-term contextual information, which may be useful for disambiguating situations or predicting future behavior based on historical patterns.

FIG. 3 is a block diagram illustrating a high-level framework for multi-spectral indicator light detection and classification of a vehicle assistance system, in accordance with the techniques of this disclosure. The architecture illustrated in FIG. 3 diverges into three specialized branches, each focusing on complementary aspects of the indicator light detection problem. The first branch 336 may be configured to understand the behavior of the vehicle being observed by analyzing its motion patterns.

As noted above, analysis of the motion patterns may be achieved by processing the temporal information captured by the hierarchical recurrent network to predict the likely actions of the vehicle and to predict changes in movement of the vehicle. This information may be highly valuable for robust indicator light detection, as the state of the indicator lights (on/off, blinking) may be often directly related to the behavior of the vehicle (braking, turning, reversing). The following equation (13) shows how the trajectory and behavior analysis 316 in the first branch 336 may produce output:

$${b}_{traj}^{( t )} = Φ t r a j ( {h}_{short}^{( t )} , {h}_{m e d i u m}^{( t )} {h}_{long}^{( t )} ) \qquad ( 13 )$$

The term

$${b}_{traj}^{( t )}$$

may represent the output of the trajectory prediction module at time t. The term

$${b}_{traj}^{( t )}$$

may be a vector containing predictions about the behavior of the vehicle and expected motion of the vehicle. The term Φtraj may denote the trajectory prediction module. The term Φtraj may be a function (e.g., a neural network or a series of connected layers) that takes the hidden state vectors from the three temporal RNNs

$$( {h}_{short}^{( t )} , {h}_{m e d i u m}^{( t )} {h}_{long}^{( t )} ) )$$

as input and may process the input parameters to generate the behavior and motion predictions. By considering information across different temporal scales, this module may make more informed predictions. The following equation (14) may detail the specific components of the

$${b}_{traj}^{( t )}$$

vector:

$${b}_{traj}^{( t )} = [ \begin{matrix}{p}_{turn \_ left} \\ {p}_{turn \_ right} \\ {p}_{teake} \\ {p}_{reverse} \\ Δ {v}_{lon} \\ Δ {v}_{lat}\end{matrix} ] \qquad ( 14 )$$

The term p_{turn_left} may be predicted probability that the vehicle will turn left. The term p_{turn_right} may be the predicted probability that the vehicle will turn right. The term Pₜₑₐₖₑ may be the predicted probability that the vehicle is braking or will brake. The term Pᵣₑᵥₑᵣₛₑ may be the predicted probability that the vehicle is reversing or will reverse. The term Δvₗₒₙ may be the expected change in longitudinal velocity (acceleration or deceleration along the direction of travel). The term Δvₗₐₜ may be expected change in lateral velocity (movement to the left or right, perpendicular to the direction of travel). The following equation (15) describes how the first four components of

$${b}_{t r a j}^{( t )}$$

(the behavioral probabilities) may be predicted:

$$[ \begin{matrix}{p}_{turn \_ left} \\ {p}_{turn \_ right} \\ {p}_{teake} \\ {p}_{reverse}\end{matrix} ] = σ ( {W}_{b} \cdot [ {h}_{short}^{( t )} ; {h}_{m e d i u m}^{( t )} ; {h}_{long}^{( t )} ] + {b}_{b} ) \qquad ( 15 )$$

The term

$$[ \begin{matrix}{p}_{turn \_ left} \\ {p}_{turn \_ right} \\ {p}_{teake} \\ {p}_{reverse}\end{matrix} ]$$

may be the vector of predicted behavioral probabilities. The term σ may represent the sigmoid activation function. The sigmoid function may output values between 0 and 1, which may be interpreted as probabilities. The term W_{b} may be a learned weight matrix. The learned weight matrix may learn the importance of different features from the concatenated hidden states for predicting each behavior. The term

$$[ {h}_{short}^{( t )} ; {h}_{m e d i u m}^{( t )} ; {h}_{long}^{( t )} ]$$

may represent the vector concatenation of the hidden state vectors from the short-term, medium-term, and long-term recurrent networks. By combining information from different temporal scales, the decoder may have a more comprehensive view of the temporal context. The term b_{b} may be a learned bias vector. The learned bias vector may add a constant offset to the weighted sum before the sigmoid activation. In summary, the first branch 336 of the disclosed architecture may work as follows: this branch may take the temporal information learned by the hierarchical recurrent network (capturing short-term, medium-term, and long-term patterns). This temporal information may be fed into a trajectory prediction module (Φₜᵣₐⱼ). This module may output a vector

$${b}_{t r a j}^{( t )}$$

that may include probabilities of discrete vehicle behaviors (turning left, turning right, braking, reversing) predicted by a predictive decoder (Equation 15). This decoder may use a weighted combination of the hidden states from the different temporal RNNs passed through a sigmoid activation. The velocity component prediction of the spatio-temporal prediction and vehicle behavior analysis 316 may be performed using the following equation (16), for example:

$$[ \begin{matrix}Δ {v}_{lon} \\ Δ {v}_{lat}\end{matrix} ] = {W}_{v} \cdot [ {h}_{short}^{( t )} ; {h}_{m e d i u m}^{( t )} ; {h}_{long}^{( t )} ] + {b}_{v} \qquad ( 16 )$$

This equation (16) describes how the expected changes in longitudinal and lateral velocities are predicted in the first branch 336. The term

$$[ \begin{matrix}Δ {v}_{lon} \\ Δ {v}_{lat}\end{matrix} ]$$

may be the vector containing the predicted change in longitudinal velocity (Δvₗₒₙ) and the predicted change in lateral velocity (Δvₗₐₜ). Advantageously, the term Wᵥ may be a learned weight matrix specifically for predicting velocity changes. The learned weight matrix may learn the relationship between the concatenated temporal hidden states and the expected velocity changes.

In an aspect, the term

$$[ {h}_{short}^{( t )} ; {h}_{m e d i u m}^{( t )} ; {h}_{long}^{( t )} ]$$

may be the vector concatenation of the hidden state vectors from the short-term, medium-term, and long-term recurrent networks, providing a comprehensive temporal context. The term bᵥ may be a learned bias vector for the velocity prediction. In essence, similar to the behavior probability prediction, the velocity components may be predicted by linearly combining the temporal features learned by the RNNs and then adding a bias. This suggests that the ML system 216 may learn to associate patterns in the vehicle's past behavior and motion (captured by the RNNs) with likely future changes in velocity of the vehicle.

In an aspect, the second branch 338 may focus on identifying potential indicator light regions in the sensor data and then may verify if these candidates exhibit the expected geometric relationships of a pair of indicator lights on a vehicle. In an aspect, the indicator lights recognition module 318 of the ML system 216 may perform candidate region extraction using the following equation (17):

B^{(t)}={b₁,b₂, . . . ,b_{N}} (17)

The term B^{(t)} may represent a set of N candidate regions identified as potential indicator lights at time t. Each element bᵢ in the set B^{(t)} may represent a detected region in the sensor data (likely in the image or a projection of the 3D data). A preliminary step may involve identifying regions that are sufficiently bright to be considered potential indicator lights. For example, the adaptive nature of the threshold may indicate that this threshold may change based on environmental conditions (e.g., lower threshold at night, higher during the day) to improve the selection of relevant candidates. The following equation (18) defines a matching score M between a pair of candidate regions bᵢ and bⱼ:

M(bᵢ,bⱼ)=α·Sim(f(bᵢ),f(bⱼ))−β·Δ_{3D}(bᵢ,bⱼ)+γ·G(bᵢ,bⱼ,θᵥ) (18)

In an aspect, this matching may be performed by pairwise feature matching module 320. A higher score suggests a stronger likelihood that these two regions correspond to a valid pair of indicator lights. The aforementioned score may be based on three factors, The first factor, Sim(f(bᵢ),f(bⱼ)), may measure the feature similarity between the two candidate regions. The term f(bᵢ) and f(bⱼ) may represent feature vectors extracted from the visual or 3D data corresponding to these regions. A higher similarity may suggest that the two regions look alike in terms of their appearance or other extracted features, which may be expected for a pair of indicator lights. The second factor, Δ_{3D}(bᵢ, bⱼ) may evaluate the 3D spatial consistency between the two regions. The second factor may measure how well the 3D positions and orientations of the two regions align with the expected spatial relationship of a pair of indicator lights on a vehicle (e.g., they should be roughly at the same height, facing backward). A smaller Δ_{3D} value may indicate better spatial consistency. The negative sign in front of this term may mean that higher spatial inconsistency penalizes the matching score. The third factor, G(bᵢ, bⱼ, θᵥ) may be a geometric consistency term that explicitly incorporates the vehicle pose θᵥ. The vehicle pose (e.g., orientation of the vehicle in 3D space) may be important for determining the expected relative positions and orientations of the indicator lights as observed by the sensor. This term may reward pairs of candidates that are geometrically consistent with the estimated vehicle pose. Finally, the terms a, B, Y may be weighting coefficients that determine the relative importance of the feature similarity, 3D spatial consistency, and vehicle pose-based geometric consistency in the overall matching score. These weights may be learned during the training process. The following equation (19) defines a specific function g(bi,bj) that contributes to the G(bi, bj, θv) term in the pairwise matching score:

$$g ( {b}_{i} , {b}_{j} ) = exp ( - \frac{{( d ( {b}_{i} , {b}_{j} ) - {μ}_{d} )}^{2}}{2 {σ}_{d}^{2}} ) \cdot exp ( - \frac{{( {Δ}_{h} ( {b}_{i} , {b}_{j} ) )}^{2}}{2 {σ}_{h}^{2}} ) \qquad ( 19 )$$

This function may evaluate the geometric consistency based on a model of typical indicator light spacing and height difference.

In an aspect, the term d(bᵢ, bⱼ) may be the 3D distance between the centroids (or some other representative points) of the two candidate regions bⱼ and bⱼ. The term ula may be the expected indicator light spacing, representing the typical distance between a pair of indicator lights on a vehicle. This value may be a fixed constant or potentially learned.

The term Δₕ(bᵢ, bᵢ) may be the height difference between the two candidate regions in 3D space. Indicator lights are typically mounted at roughly the same height. The terms σ_{d} and σₕ may be learned variance parameters that represent the expected variability or tolerance around the expected indicator light spacing and height difference, respectively. Larger variances may allow for more flexibility in the geometric relationships. The term exp( . . . ) may be the exponential function with a negative quadratic term that may create a Gaussian-like shape. In other words, for example, the value of g(bᵢ, bⱼ) may be highest when the observed distance and height difference are close to the expected values (μ_{d} and 0, respectively) and may decrease as these differences increase. In summary, the second branch 338 may operate by identifying bright candidate regions in the sensor data using indicator lights recognition module 318. Next, the second branch 338 may evaluate pairs of these candidates, using the pairwise feature matching module 320, for example, based on: feature similarity (how alike they look), 3D spatial consistency (how well their 3D properties align) and geometric consistency with vehicle pose (how well the relative positions and orientations of candidates match expectations given the estimated vehicle pose).

The following equation (20) defines the output of the second branch 338, which may be a set of candidate indicator light pairs along with their corresponding matching confidence scores:

$${c}_{pmatch}^{( t )} = \{ ( {b}_{i} , {b}_{j} , M ( {b}_{i} , {b}_{j} ) ) \vert ( {b}_{i} , {b}_{j} ) ∈ {B}^{( t )} \times {B}^{( t )} , i \neq j \} \qquad ( 20 )$$

The term

$${c}_{pmatch}^{( t )}$$

may represent the set of potential indicator light pairs and their associated confidence scores at time t. The term (bᵢ, bⱼ) may be a pair of candidate regions extracted in the previous step of Branch B (from the set B^{(t)}). The term M(bᵢ, bⱼ) may be the matching score calculated for the pair of regions (bᵢ, bⱼ) using Equation (17). For example, this term may represent the confidence that these two regions constitute a valid pair of indicator lights based on their feature similarity, 3D spatial consistency, and geometric consistency with the vehicle pose. The term (bᵢ, bⱼ)∈B^{(t)}×B^{(t)} may indicate that the set

$${c}_{pmatch}^{( t )}$$

may include scores for all possible pairs of candidate regions from the set B^{(t)}. The Cartesian product B^{(t)}×B^{(t)} may generate, for example, all ordered pairs of elements from B^{(t)}. The condition i≠j may be the condition that better ensures that a region may not be paired with itself. An indicator light pair should consist of two distinct regions. In essence, the second branch 338 may not just identify individual candidates. The second branch 338 may evaluate all possible pairings of these candidates and may assign a confidence score to each pair based on their geometric plausibility as indicator lights on a vehicle. For illustrative purposes only consider a scenario where the output may be a set of these pairs and their confidence levels.

In an aspect, the third branch 340 may focus on analyzing the light intensity patterns of the candidate regions over time and across different spectral bands (RGB and potentially NIR). This analysis may help in distinguishing indicator lights from other light sources by examining their characteristic spectral properties and temporal behaviors (like flickering for LED turn signals). The following equations (21) and (22) define adaptive brightness thresholds for the RGB and NIR channels, respectively:

T_{rgb}=γ_{rgb}·μ_{rgb}+δ_{rgb}·σ_{rgb}+κ_{rgb} (21)

Tₙᵢᵣ=γₙᵢᵣ·μₙᵢᵣ+δₙᵢᵣ·σₙᵢᵣ+κₙᵢᵣ (22)

These thresholds may be used in the initial candidate region extraction (mentioned in the description of the second branch 338) or in subsequent analysis within the third branch 340 to further refine the selection of potential indicator light regions. The term T_{rgb} may be the adaptive brightness threshold for the RGB image.

In an aspect, the term Tₙᵢᵣ may be the adaptive brightness threshold for the NIR image. The terms μ_{rgb} and μₙᵢᵣ may be the mean intensity of the RGB images 304 and NIR images 306, respectively. The terms σ_{rgb} and σₙᵢᵣ may be standard deviation of the intensity of the RGB images 304 and NIR images 306, respectively. The terms γ_{rgb} σ_{rgb} and κ_{rgb} may be parameters that are adapted based on ambient conditions for the RGB threshold. These parameters may control how much the threshold is influenced by the overall image brightness (mean) and contrast (standard deviation), as well as a constant offset. The terms γₙᵢᵣ δₙᵢᵣ and κₙᵢᵣ may be similar parameters adapted based on ambient conditions for the NIR threshold. The adaptive nature of these thresholds may be important for robustness across varying lighting conditions. For example, in a dark environment (low μ), the threshold may be lowered to detect faint lights. In a high-contrast scene (high σ), the threshold may be adjusted to be more selective. In one example, ambient condition parameters (γ, δ, κ) may allow the ML system 216 to fine-tune these adjustments based on specific environmental factors (e.g., day/night, weather). The following equations (23) and (24) describe how the temporal intensity patterns of a candidate region bi in the RGB and NIR channels, respectively, may be analyzed in the frequency domain using the Fast Fourier Transform (FFT) by Fourier Spectral analysis module 322:

F_{rgb}(bᵢ)=FFT(I_{rgb}(bᵢ,t−K:t)) (23)

Fₙᵢᵣ(bᵢ)=FFT(Iₙᵢᵣ(bᵢ,t−K:t)) (24)

The term F_{rgb}(bᵢ) may be the frequency spectrum of the RGB intensity of region bᵢ over a recent temporal window. The term Fₙᵢᵣ(bᵢ) may be the frequency spectrum of the NIR intensity of region bᵢ over the same recent temporal window. The term FFT( . . . ) may be the Fast Fourier Transform algorithm. The FFT may decompose a time-domain signal (the sequence of intensity values over time) into its constituent frequencies. The term I_{rgb}(bᵢ, t−K:t) may represent the sequence of average (or some other representative) RGB intensity values of the candidate region bᵢ over the past K time steps (from t−K to t). The term Iₙᵢᵣ(bᵢ, t−K:t) may similarly represent the sequence of average NIR intensity values of the candidate region bᵢ over the same past K time steps.

The following equations (25) and (26) describe an alternative method for analyzing the temporal intensity patterns of candidate regions, using the Continuous Wavelet Transform (CWT):

W_{rgb}(bᵢ)=CWT(I_{rgb}(bᵢ,t−K:t)) (25)

Wₙᵢᵣ(bᵢ)=CWT(Iₙᵢᵣ(bᵢ,t−K:t)) (26)

In an aspect, the term W_{rgb}(bᵢ) may be the wavelet transform coefficients of the RGB intensity of region bᵢ over the recent temporal window. The term Wₙᵢᵣ(bᵢ) may be the wavelet transform coefficients of the NIR intensity of region bᵢ over the same temporal window. The term CWT( . . . ) may be The Continuous Wavelet Transform. Unlike the FFT, which may provide a global frequency analysis, the CWT may provide a time-frequency representation. In other words, the CWT may show how the frequency content of the signal changes over time. In an aspect, this may be particularly useful for analyzing non-stationary signals where frequencies may appear and disappear or change over time, which is characteristic of blinking lights. More specifically, the CWT may also be performed at multiple scales, allowing the analysis of both fine and coarse temporal details. The terms I_{rgb}(bᵢ, t−K:t) and Iₙᵢᵣ(bᵢ, t−K:t) may be the same temporal intensity sequences as used in the FFT analysis. By using the CWT, the ML system 216 may capture more nuanced temporal patterns than just the dominant frequencies, potentially identifying the start and end times of blinks, the rate of change of intensity, and other time-varying characteristics of the light signals in both RGB and NIR channels. The following equation (27) defines the output of the third branch 340 for each candidate region bᵢ identified in Branch B

$${a}_{adapt}^{( t )} = \{ ( {b}_{i} , {T}_{rgb} , {T}_{nir} , {F}_{rgb} ( {b}_{i} ) , {F}_{nir} ( {b}_{i} ) , {W}_{rgb} ( {b}_{i} ) , {W}_{nir} ( {b}_{i} ) ) \vert {b}_{i} ∈ {B}^{( t )} \} \qquad ( 27 )$$

In the illustrated scenario, the term

$${a}_{adapt}^{( t )}$$

may be a sei containing information about each candidate region at time t, based on the spectral and temporal analysis. The term bᵢ may be the candidate region itself. The terms T_{rgb}, Tₙᵢᵣ may be the adaptive brightness thresholds for RGB and NIR, respectively (from Equations 21 and 22). These terms may be used to filter or weigh the importance of the candidate region. The terms F_{rgb}(bᵢ) and Fₙᵢᵣ(bᵢ)) may be the frequency spectra of the temporal intensity patterns in RGB and NIR (from Equations 23 and 24), capturing flicker information. The terms W_{rgb}(bᵢ) and Wₙᵢᵣ (bᵢ) may be the wavelet transform coefficients of the temporal intensity patterns in RGB and NIR (from Equations 25 and 26), capturing time-frequency characteristics. In summary, the third branch 340 may provide a rich set of features for each candidate region, characterizing its brightness relative to adaptive thresholds and its temporal behavior in both the frequency and time-frequency domains across RGB and NIR channels. This information may be important for distinguishing actual indicator lights with their specific spectral and temporal signatures from other light sources. In an aspect, the information from the three specialized branches 336, 338, 340 may be combined to make a final decision about indicator light detection. In other words, the disclosed architecture may employ a hierarchical attention mechanism for this fusion, which may be implemented by the hierarchical attention fusion layer 326. The following equation (28) shows the inputs to the attention-based fusion mechanism:

$${v}^{( t )} = AttFusion ( {b}_{traj}^{( t )} , {c}_{pmatch}^{( t )} , {a}_{adapt}^{( t )} , {C}_{env} ) \qquad ( 28 )$$

The term v^{(t)} may represent the fused feature vector at time t, which may be used for the final indicator light detection and classification. The term AttFusion may be the multi-head attention mechanism that may perform the fusion. The term

$${b}_{traj}^{( t )}$$

may be the output of the first branch 336 (trajectory and behavior analysis), containing predicted behavioral probabilities and velocity changes (from Equation 14). The term

$${c}_{pmatch}^{( t )}$$

may be the output of the second branch 338 (geometric consistency analysis), a set of candidate indicator light pairs with their matching confidence scores (from Equation 20). The term

$${a}_{adapt}^{( t )}$$

may be the output of the third branch 340 (spectral and temporal signal analysis), a set of features for each candidate region including threshold information and spectral/wavelet representations of temporal intensity (from Equation 27). The term Cₑₙᵥ in the disclosed techniques may represent the environmental context. In general, this context may include, but is not limited to, information about the time of day, weather conditions, road conditions, etc. This global context may be used to modulate the fusion process. The following equation (29) details the structure of the AttFusion mechanism:

$$AttFusion ( {x}_{1} , {x}_{2} , {x}_{3} , c ) = {\sum }_{i = 1}^{3} {α}_{i} ( c ) \cdot {Proj}_{i} ( {x}_{i} ) \qquad ( 29 )$$

This attention mechanism may be a simplified form of attention, representing a weighted sum of projected inputs from the three branches. The terms x₁, x₂, x₃ may correspond to the inputs from the three branches. The term c may represent the environmental context Cₑₙᵥ. The term αᵢ(c) may be an attention weight assigned to the output of the i-th branch. These weights may be dependent on the environmental context c. In other words, the importance of each branch's information in the fusion process may be dynamically adjusted based on the prevailing conditions. For example, in poor visibility, the geometric cues from the second branch 338 or the temporal signatures from the third branch 340 may be weighted more heavily than the trajectory predictions from the first branch 336. The term Projᵢ(xᵢ) may represent a projection function (likely a linear layer or a small neural network) applied to the output of the i-th branch (xᵢ). These projections may transform the features from each branch into a common embedding space, making the features comparable for the attention mechanism. In essence, the hierarchical attention-based fusion mechanism may work by processing the outputs of the three specialized branches. This attention mechanism may project these outputs into a common feature space. Advantageously, the attention mechanism may also dynamically weight the contribution of each branch's projected features based on the current environmental context. For example, the attention weights αᵢ(c) may learn to prioritize the most relevant information from each branch depending on factors like lighting, weather, etc.

The following equation (30) defines the attention weights αᵢ(c):

$${α}_{i} ( c ) = \frac{exp ( {s}_{i} ( c ) )}{{\sum }_{j = 1}^{3} exp ( {s}_{j} ( c ) )} \qquad ( 30 )$$

The equation (30) is a component of the hierarchical attention-based fusion mechanism described herein. The term at (c) may represent the attention weight assigned to the i-th input source (where i ranges from 1 to 3 in this context, corresponding to the three branches: trajectory, pattern matching, and spectral/temporal analysis). The weight αᵢ(c) may be conditioned on the context vector c (Cₑₙᵥ in Equation 28). In other words, the importance given to each input source may change depending on the environmental context. The term sᵢ(c) may be a score for the i-th input source, again conditioned on the context c. This term may be a learned projection function specific to the i-th input source. The role of this function may be to transform the raw features into a new representation space that is likely more suitable for comparison and fusion. This projection functions may be learned during the training process. For example, a weight vector may be learned during training to determine the importance of different dimensions within the concatenated vector. In summary, sᵢ(c) may calculate a context-aware score for each input source by first projecting its features, combining them with the context, and then applying a learned linear transformation (weighted sum and bias).

In essence, the equation (30) describes how the attention weights for each input branch are computed: each input branch's features may be first transformed by a learned projection function. The projected features may then be combined (concatenated) with the environmental context vector (c). A learned linear layer may calculate a score sᵢ(c) for each branch, indicating its relevance in the current context. The SoftMax function may be applied to these scores to produce the attention weights (αᵢ(c)). These weights represent the relative importance of each branch's contribution to the final fused feature vector v(t) (as seen in Equation 29).

The following equation (31) describes the output of the final classification layer:

$$[ \begin{matrix}{P}_{left}^{( t )} & {U}_{left}^{( t )} \\ {P}_{right}^{( t )} & {U}_{right}^{( t )} \\ {P}_{brake}^{( t )} & {U}_{brake}^{( t )} \\ {P}_{reverse}^{( t )} & {U}_{reverse}^{( t )}\end{matrix} ] = Ψ ( {v}^{( t )} ) \qquad ( 31 )$$

The matrix on the left-hand side may represent the output of the final classification layer at time t. Each row may correspond to a different class (left, right, brake, reverse). For each class, the layer may output two values.

$${P}_{label}^{( t )}$$

may be the predicted probability for that specific class at time t. This probability may represent the model's confidence that the input belongs to that class. For example,

$${P}_{left}^{( t )}$$

may be the probability that the action at time t is “left.” These probabilities will typically sum to 1 across all classes (although EDL can have slight deviations from this in its raw outputs before normalization). The term

$${U}_{label}^{( t )}$$

may be the uncertainty estimate associated with the predicted probability for that specific class at time t. This term may quantify how unsure the model is about its prediction for that class. A higher U value may indicate greater uncertainty, while a lower U value may indicate more confidence in the prediction. The function on the right-hand side Ψ(v^{(t)}) may represent the final classification layer function Ψ taking the fused feature vector v(t) as input. Recall from Equation (28) that v(t) is the result of the hierarchical attention-based fusion of information from different analysis branches. Therefore, the classification decision may be made based on the combined and contextually weighted information. In essence, the equation (31) highlights that the final layer may not just output a single predicted class but may provide a probability distribution over all possible classes along with an explicit measure of uncertainty for each prediction.

The following equation (32) describes implementation with Evidential Deep Learning (EDL):

Ψ(v)=EDL(W_{Ψ}·v+b_{Ψ}) (32)

The term Ψ(v) is the same final classification layer function as in equation (31), now shown in terms of its implementation. The term v may be the input to the final layer (corresponding to v(t)). The term W_{Ψ} may be a learned weight matrix for the final classification layer. This term may perform a linear transformation on the input feature vector. The term b_{Ψ} may be a learned bias vector for the final classification layer. This term may add a constant offset after the linear transformation. The term W_{Ψ}·v+b_{Ψ} is a standard affine transformation (linear transformation followed by a bias addition) commonly used in neural network layers. The term EDL(⋅) signifies that the output of the affine transformation is then passed through an Evidential Deep Learning (EDL) model. This model is the part that may enable the uncertainty estimation.

Advantageously, instead of directly predicting probabilities, the model may learn to predict the parameters of a Dirichlet distribution. The Dirichlet distribution is a probability distribution over the simplex of probability vectors (i.e., it can model the probabilities of a multinomial distribution). The EDL model may take the features from the previous layers (after the affine transformation) and may output a set of positive scalar values, which may be the parameters of a Dirichlet distribution for each data point. For a classification problem with K classes, the Dirichlet distribution has K parameters. These Dirichlet parameters may be interpreted as representing the amount of evidence the model has gathered for each class. The sum of all Dirichlet parameters, S, may represent the total amount of evidence the model has about the classification. A higher S may indicate more overall confidence, while a lower S may indicate less confidence (higher uncertainty). The predicted probability for each class i may be derived from the Dirichlet parameters as the expected value of the Dirichlet distribution. Uncertainty may be quantified in several ways using the Dirichlet parameters. The Dirichlet distribution may allow for the calculation of the variance of the predicted probabilities. A higher variance may indicate greater uncertainty. As mentioned earlier, a lower total evidence S may directly imply higher uncertainty. Various uncertainty metrics may be derived based on S.

In an aspect, the ML system 216 may recognize that different types of light signals evolve at different rates. To effectively capture these diverse temporal patterns, the ML system 216 may process the light intensity (denoted by I at time t) at three distinct scales. At micro-scale (1-10 ms), the ML system 216 may capture LED PWM patterns and rapid intensity changes, as described by the following equation (33):

F_{micro}(I,t)=FFT(I_{t-m:t}) (33)

This scale may focus on very short time intervals, ranging from 1 to 10 milliseconds. This scale may be designed to detect rapid changes in light intensity, such as those caused by Pulse Width Modulation (PWM) used in LEDs to control brightness, or other very fast flickering effects. The FFT may be applied to the light intensity signal (I) within the micro-scale time window. As explained above, FFT may decompose the time-domain signal into its constituent frequencies. This may allow the ML system 216 to analyze the frequency components of the rapid intensity fluctuations, which may be characteristic of LED PWM or other fast periodic signals. The ML system 216 may also analyze turn signals and brake pulses at meso-scale (100 ms-1 s) using the following equation (34)

Fₘₑₛₒ(I,t)=Wavelet(I_{t-n:t}) (34)

This scale may examine intermediate time intervals, ranging from 100 milliseconds to 1 second. This scale may be suitable for analyzing patterns that occur at a medium pace, such as the on-off cycles of turn signals or the relatively short duration of brake light pulses. The Wavelet transform may be applied to the light intensity signal within the meso-scale time window. As previously discussed, the Wavelet transform may provide a time-frequency representation, allowing the ML system 216 to see how different frequency components of the signal change over time. This may be useful for analyzing non-stationary signals like turn signals and brake pulses, where the frequency content might vary during the event. Finally, the ML system 216 may track consistent light behaviors over time using the following equation (35)

F_{macro}(I,t)=LSTM(I_{t-p:t}) (35)

This scale may look at longer time intervals, ranging from 1 to 10 seconds. This macro scale may be designed to capture more sustained or consistent light behaviors that unfold over several seconds. Examples could include, but are not limited to a vehicle's headlights being consistently on, a hazard light flashing at a regular interval, or a brake light remaining illuminated for an extended period. A Long Short-Term Memory (LSTM) network may be applied to the light intensity signal within the macro-scale time window. LSTMs are a type of recurrent neural network (RNN) specifically designed to learn and remember patterns over long sequences of data. By processing the temporal sequence of light intensities, the LSTM may learn to recognize and represent longer-term dependencies and consistent behaviors in the light signals. The following equation (36) describes how the features extracted at the three different temporal scales are combined into a single, unified temporal feature representation:

Fₜₑₘₚₒᵣₐₗ(I,t)=CrossScaleAttention(F_{micro},Fₘₑₛₒ,F_{macro}) (36)

This function may represent an attention mechanism that learns to weigh the importance of the features from each scale F_{micro}, Fₘₑₛₒ, and F_{macro} based on the current context or the specific light signal being analyzed. Accordingly, the ML system 216 may effectively analyze both rapid, short-duration events (micro-scale) and slower, longer-lasting patterns (macro-scale), as well as intermediate behaviors (meso-scale). The cross-scale attention mechanism may allow the ML system 216 to dynamically focus on the most relevant temporal scale for the current signal. For example, when analyzing a rapidly flickering LED, the micro-scale features may be given more weight. When analyzing a turn signal, the meso-scale features would likely be more important. For sustained behaviors, the macro-scale features would dominate.

In an aspect the following equation (37) describes self-supervised consistency learning:

[symbol]

_{consistency}=Σ_{i≠j}D_{KL}(Pᵢ∥Pⱼ) (37)

This equation represents the consistency loss, a component of the overall training objective function. The goal of this loss term may be to encourage the predictions made by different modalities to be consistent with each other, even without explicit ground truth labels for this consistency. This may be a form of self-supervision because the supervision signal comes from the agreement (or disagreement) between the model's own predictions across different input types. The [symbol] _{consistency} term may penalize the model when the predictions made by different modalities (Pᵢ and Pⱼ) are significantly different. The different modalities may capture complementary aspects of the same underlying scene or event. Enforcing consistency may encourage the ML model to learn the shared information that is relevant for making the correct predictions, regardless of the input modality. If one modality is noisy or partially occluded, the consistency constraint may help the model rely more on the predictions from other, more reliable modalities.

In an aspect, the following equation (38) describes resource-efficient adaptive computation framework:

Complexity^{(t)}=f(EnvComplexity^{(t)},ResourceAvailable^{(t)}) (38)

The term Complexity (t) may represent the computational complexity that the ML system 216 will employ at time t. This could refer to various aspects of the computation, such as, but not limited to: the depth or width of the neural network being used; the resolution of the input data being processed; the number of attention heads or other computationally intensive operations; the frequency at which the system performs certain analyses. When the environment is more complex (e.g., poor visibility), the ML system 216 may need to increase computational resources to process the data more thoroughly and maintain reliability. This increase could involve using a deeper network, processing at a higher resolution, or increasing the number of computations. If the hardware has limited resources or is already heavily loaded, the ML system 216 may need to adapt by reducing computational complexity to avoid overloading or performance degradation. For critical tasks requiring fast responses (e.g., emergency braking), the ML system 216 may need to prioritize speed over extreme detail, potentially by using a less computationally intensive model or processing pipeline. Advantageously, the ML system 216 may operate efficiently on various hardware platforms, from high-performance units to resource-constrained embedded devices, by adjusting its computational demands to match the available resources. By increasing computational complexity when the environment is challenging, the ML system 216 may maintain a higher level of reliability and accuracy even in adverse conditions.

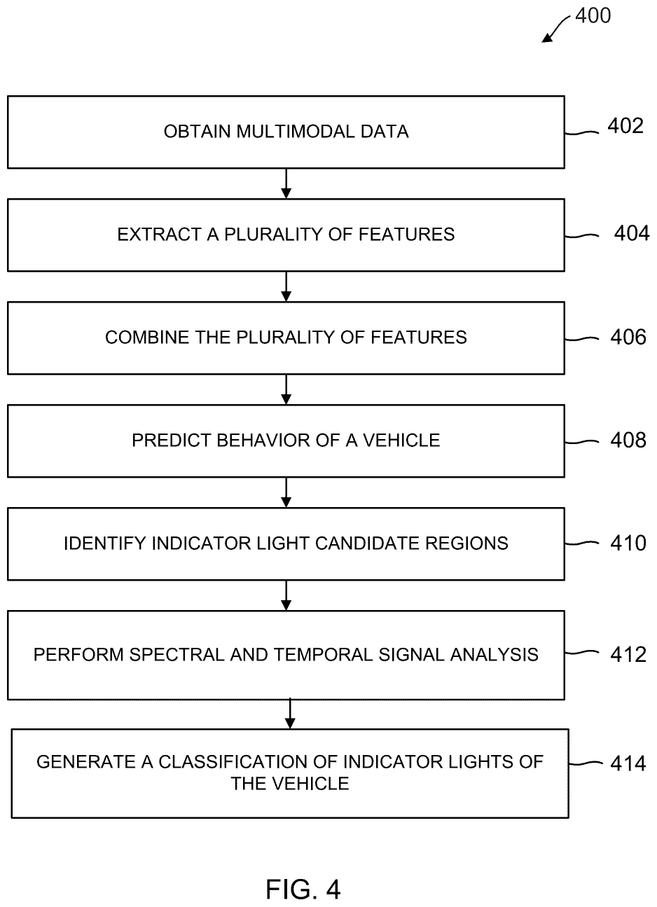

FIG. 4 is a flowchart illustrating an example method for indicator light detection and classification by a vehicle assistance system, in accordance with the techniques of this disclosure. Although described with respect to computing system 200 (FIG. 2), it should be understood that other devices may be configured to perform a method similar to that of FIG. 4.

In this example, ML system 216 may initially obtain multimodal input data from a plurality of sensors of vehicle 102 (402). For example, the camera pictures (e.g. pictures 304 shown in FIG. 3), NIR data and LiDAR data may provide a comprehensive view of the environment surrounding a vehicle assistance system. Next, ML system 216 may extract a plurality of features from the multimodal data (404). As a non-limiting example, these features may be intended to capture the most important information from each modality for the task of indicator light detection and classification. ML system 216 may then combine the plurality of features using a weighted fusion technique to generate a plurality of combined features (406). In an aspect, ML system 216 may apply equation (4) described above to perform this fusion technique. Next, ML system 216 may predict, based on the plurality of combined features, behavior of the vehicle (408). In an aspect, a trajectory prediction module may output a vector that may include probabilities of discrete vehicle behaviors (turning left, turning right, braking, reversing) predicted by a predictive decoder (see equation (15) above). In accordance with the techniques of the present disclosure, ML system 216 may also identify, based on the plurality of combined features, one or more indicator light candidate regions and may perform geometric consistency analysis for the one or more indicator light candidate regions (410). The function describing by equation (19) may evaluate the geometric consistency based on a model of typical indicator light spacing and height difference. In addition, ML system 216 may perform, based on the plurality of combined features, spectral and temporal signal analysis (412). This analysis may help in distinguishing indicator lights from other light sources by examining their characteristic spectral properties and temporal behaviors (like flickering for LED turn signals). Finally, ML system 216 may concatenate, using a hierarchical attention-based fusion, prediction of the behavior of the vehicle with results of the geometric consistency analysis and results of the spectral and temporal signal analysis to generate classification of detected indicator lights of the vehicle (414). In essence, the hierarchical attention-based fusion mechanism may work by processing the outputs of the three specialized branches, as described above.

The following numbered clauses illustrate one or more aspects of the devices and techniques described in this disclosure.

Clause 1. A method for indicator light detection and classification by a vehicle assistance system, the method comprising: obtaining multimodal data from a plurality of sensors; extracting a plurality of features from the multimodal data; combining the plurality of features using a multimodal feature fusion to generate a plurality of combined features; predicting, based on the plurality of combined features, behavior of a vehicle; identifying, based on the plurality of combined features, one or more indicator light candidate regions of the vehicle and performing geometric consistency analysis for the one or more indicator light candidate regions; performing, based on the plurality of combined features, spectral and temporal signal analysis; and concatenating, using a hierarchical attention-based fusion, prediction of the behavior of the vehicle with results of the geometric consistency analysis and results of the spectral and temporal signal analysis to generate a classification of indicator lights of the vehicle.

Clause 2. The method of clause 1, wherein extracting the plurality of features from the multimodal data further comprises extracting the plurality of features using one or more of: a camera feature encoder, a Near-InfraRed (NIR) feature encoder and a LiDAR feature encoder.

Clause 3. The method of clause 2, wherein the camera feature encoder comprises a machine learning model having one or more self-adjusting receptive fields.

Clause 4. The method of clause 1, further comprising: analyzing ambient context of an environment surrounding the vehicle; and adjusting, based on the ambient context, the prediction of the behavior of the vehicle, the results of the geometric consistency analysis and the results of the spectral and temporal signal analysis.

Clause 5. The method of clause 1, wherein performing the spectral and temporal signal analysis further comprises performing the spectral and temporal signal analysis using adaptive thresholding.

Clause 6. The method of clause 1, wherein performing the spectral and temporal signal analysis further comprises performing the spectral and temporal signal analysis using a temporal pattern recognition.

Clause 7. The method of clauses 1-6, further comprising: synchronizing the multimodal data using a history buffer.

Clause 8. The method of clauses 1-7, wherein extracting the plurality of features from the multimodal data further comprises: generating one or more feature vectors; and assigning one or more weighting factors to the one or more feature vectors.

Clause 9. The method of clauses 1-8, further comprising: operating the vehicle assistance system using the classification of indicator lights.

Clause 10. A system for indicator light detection and classification by a vehicle assistance system, the system comprising: a memory for storing multimodal data; and processing circuitry in communication with the memory, wherein the processing circuitry is configured to: obtain the multimodal data from a plurality of sensors; extract a plurality of features from the multimodal data; combine the plurality of features using a multimodal feature fusion to generate a plurality of combined features; predict, based on the plurality of combined features, behavior of a vehicle; identify, based on the plurality of combined features, one or more indicator light candidate regions of the vehicle and perform geometric consistency analysis for the one or more indicator light candidate regions; perform, based on the plurality of combined features, spectral and temporal signal analysis; and concatenate, using a hierarchical attention-based fusion, prediction of the behavior of the vehicle with results of the geometric consistency analysis and results of the spectral and temporal signal analysis to generate a classification of indicator lights of the vehicle.

Clause 11. The system of clause 10, wherein the processing circuitry configured to extract the plurality of features from the multimodal data is further configured to: extract the plurality of features using one or more of: a camera feature encoder, a Near-InfraRed (NIR) feature encoder and a LiDAR feature encoder.

Clause 12. The system of clause 11, wherein the camera feature encoder comprises a machine learning model having one or more self-adjusting receptive fields.

Clause 13. The system of clause 10, wherein the processing circuitry is further configured to: analyze ambient context of an environment surrounding the vehicle; and adjust, based on the ambient context, the prediction of the behavior of the vehicle, the results of the geometric consistency analysis and the results of the spectral and temporal signal analysis.

Clause 14. The system of clause 10, wherein the processing circuitry configured to perform the spectral and temporal signal analysis is further configured to: perform the spectral and temporal signal analysis using adaptive thresholding.

Clause 15. The system of clause 10, wherein the processing circuitry configured to perform the spectral and temporal signal analysis is further configured to: perform the spectral and temporal signal analysis using a temporal pattern recognition.

Clause 16. The system of clauses 10-15, wherein the processing circuitry is further configured to: synchronize the multimodal data using a history buffer.

Clause 17. The system of clauses 10-16, wherein the processing circuitry configured to extract the plurality of features from the multimodal data is further configured to: generate one or more feature vectors; and assign one or more weighting factors to the one or more feature vectors.

Clause 18. The system of clauses 10-17, wherein the processing circuitry is further configured to: operate a vehicle assistance system using the classification of indicator lights.

Clause 19. Non-transitory computer-readable storage media having instructions encoded thereon, the instructions configured to cause processing circuitry to: obtain multimodal data from a plurality of sensors; extract a plurality of features from the multimodal data; combine the plurality of features using a multimodal feature fusion to generate a plurality of combined features; predict, based on the plurality of combined features, behavior of a vehicle; identify, based on the plurality of combined features, one or more indicator light candidate regions of the vehicle and perform geometric consistency analysis for the one or more indicator light candidate regions; perform, based on the plurality of combined features, spectral and temporal signal analysis; and concatenate, using a hierarchical attention-based fusion, prediction of the behavior of the vehicle with results of the geometric consistency analysis and results of the spectral and temporal signal analysis to generate a classification of indicator lights of the vehicle.

Clause 20. The storage media of clause 19, wherein the instructions configured to cause processing circuitry to extract the plurality of features from the multimodal data are further configured to cause the processing circuitry to: extract the plurality of features using one or more of: a camera feature encoder, a Near-InfraRed (NIR) feature encoder and a LiDAR feature encoder.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules or units configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for indicator light detection and classification by a vehicle assistance system, the method comprising:
obtaining multimodal data from a plurality of sensors;
extracting a plurality of features from the multimodal data;
combining the plurality of features using a multimodal feature fusion to generate a plurality of combined features;
predicting, based on the plurality of combined features, behavior of a vehicle;
identifying, based on the plurality of combined features, one or more indicator light candidate regions of the vehicle and performing geometric consistency analysis for the one or more indicator light candidate regions;
performing, based on the plurality of combined features, spectral and temporal signal analysis; and
concatenating, using a hierarchical attention-based fusion, prediction of the behavior of the vehicle with results of the geometric consistency analysis and results of the spectral and temporal signal analysis to generate a classification of indicator lights of the vehicle.

2. The method of claim 1, wherein extracting the plurality of features from the multimodal data further comprises extracting the plurality of features using one or more of: a camera feature encoder, a Near-InfraRed (NIR) feature encoder and a LiDAR feature encoder.

3. The method of claim 2, wherein the camera feature encoder comprises a machine learning model having one or more self-adjusting receptive fields.

4. The method of claim 1, further comprising:
analyzing ambient context of an environment surrounding the vehicle; and
adjusting, based on the ambient context, the prediction of the behavior of the vehicle, the results of the geometric consistency analysis and the results of the spectral and temporal signal analysis.

5. The method of claim 1, wherein performing the spectral and temporal signal analysis further comprises performing the spectral and temporal signal analysis using adaptive thresholding.

6. The method of claim 1, wherein performing the spectral and temporal signal analysis further comprises performing the spectral and temporal signal analysis using a temporal pattern recognition.

7. The method of claim 1, further comprising:
synchronizing the multimodal data using a history buffer.

8. The method of claim 1, wherein extracting the plurality of features from the multimodal data further comprises:
generating one or more feature vectors; and
assigning one or more weighting factors to the one or more feature vectors.

9. The method of claim 1, further comprising:
operating the vehicle assistance system using the classification of indicator lights.

10. A system for indicator light detection and classification by a vehicle assistance system, the system comprising:
a memory for storing multimodal data; and
processing circuitry in communication with the memory, wherein the processing circuitry is configured to:
obtain the multimodal data from a plurality of sensors;
extract a plurality of features from the multimodal data;
combine the plurality of features using a multimodal feature fusion to generate a plurality of combined features;
predict, based on the plurality of combined features, behavior of a vehicle;
identify, based on the plurality of combined features, one or more indicator light candidate regions of the vehicle and perform geometric consistency analysis for the one or more indicator light candidate regions;
perform, based on the plurality of combined features, spectral and temporal signal analysis; and
concatenate, using a hierarchical attention-based fusion, prediction of the behavior of the vehicle with results of the geometric consistency analysis and results of the spectral and temporal signal analysis to generate a classification of indicator lights of the vehicle.

11. The system of claim 10, wherein the processing circuitry configured to extract the plurality of features from the multimodal data is further configured to:
extract the plurality of features using one or more of: a camera feature encoder, a Near-InfraRed (NIR) feature encoder and a LiDAR feature encoder.

12. The system of claim 11, wherein the camera feature encoder comprises a machine learning model having one or more self-adjusting receptive fields.

13. The system of claim 10, wherein the processing circuitry is further configured to:
analyze ambient context of an environment surrounding the vehicle; and
adjust, based on the ambient context, the prediction of the behavior of the vehicle, the results of the geometric consistency analysis and the results of the spectral and temporal signal analysis.

14. The system of claim 10, wherein the processing circuitry configured to perform the spectral and temporal signal analysis is further configured to:
perform the spectral and temporal signal analysis using adaptive thresholding.

15. The system of claim 10, wherein the processing circuitry configured to perform the spectral and temporal signal analysis is further configured to:
perform the spectral and temporal signal analysis using a temporal pattern recognition.

16. The system of claim 10, wherein the processing circuitry is further configured to:
synchronize the multimodal data using a history buffer.

17. The system of claim 10, wherein the processing circuitry configured to extract the plurality of features from the multimodal data is further configured to:
generate one or more feature vectors; and
assign one or more weighting factors to the one or more feature vectors.

18. The system of claim 10, wherein the processing circuitry is further configured to:
operate a vehicle assistance system using the classification of indicator lights.

19. Non-transitory computer-readable storage media having instructions encoded thereon, the instructions configured to cause processing circuitry to:
obtain multimodal data from a plurality of sensors;
extract a plurality of features from the multimodal data;
combine the plurality of features using a multimodal feature fusion to generate a plurality of combined features;
predict, based on the plurality of combined features, behavior of a vehicle;
identify, based on the plurality of combined features, one or more indicator light candidate regions of the vehicle and perform geometric consistency analysis for the one or more indicator light candidate regions;
perform, based on the plurality of combined features, spectral and temporal signal analysis; and
concatenate, using a hierarchical attention-based fusion, prediction of the behavior of the vehicle with results of the geometric consistency analysis and results of the spectral and temporal signal analysis to generate a classification of indicator lights of the vehicle.

20. The storage media of claim 19, wherein the instructions configured to cause processing circuitry to extract the plurality of features from the multimodal data are further configured to cause the processing circuitry to:
extract the plurality of features using one or more of: a camera feature encoder, a Near-InfraRed (NIR) feature encoder and a LiDAR feature encoder.
